(19) United States
(12) Patent Application Publication
(10) Pub. No.: US 2010/0300190 A1
(43) Pub. Date: Dec. 2, 2010

(54) MONOCOQUE OF VEHICLE CAPABLE OF DETECTING STRAIN

(75) Inventor: Huan-Lung GU, Hsinchu County (TW)

Correspondence Address: BACON & THOMAS, PLLC, 625 SLATERS LANE, FOURTH FLOOR, ALEXANDRIA, VA, 22314-1176, US

(73) Assignee: INDUSTRIAL TECHNOLOGY RESEARCH INSTITUTE, Chutung Chen (TW)

(21) Appl. No.: 12/855,031

(22) Filed: Aug. 12, 2010

Related U.S. Application Data
(63) Continuation of application No. 11/252,756, filed on Oct. 19, 2005.

(51) Int. Cl. G01M 17/04

(52) U.S. Cl. 73/117.01

(57) ABSTRACT

A monocoque of a vehicle capable of detecting strain includes a housing and a plurality of stress-strain sensors installed in the housing for detecting the direction and amount of any strain applied to the housing to enable the housing to become a large strain-detecting unit. Strain data generated while the stress-strain sensors function can identify how much strain the monocoque takes, such that preferable status of the monocoque of the vehicle can be provided.

### CROSS REFERENCE TO RELATED APPLICATIONS

The present application is a continuation-in-part of U.S. application Ser. No. 11/252,756 entitled INTELLIGENT CHASSIS MECHANISM CAPABLE OF DETECTING STRAIN filed on Oct. 19, 2005, the disclosure of which is incorporated herein by reference.

### BACKGROUND OF THE INVENTION

1. Field of the Invention

The present invention relates generally to artificial intelligent technology, and more particularly to a monocoque of a vehicle capable of detecting strain.

2. Description of the Related Art

A vehicle is a well-developed public transportation means having the history of more than one hundred years. Following fast development of modern technology and civilization, different intelligent vehicles of different shapes and functions have been developed. These intelligent vehicles are the combination of enginery and microcomputer technology. The chassis is the main structure of a vehicle and supports the whole vehicle system. Until now, any breakthrough in design of chassis has not been made.

With respect to strain detection, U.S. Pat. No. 3,934,663, entitled “Attachment Device for a Gauge”, disclosed that the sensor means mounted under the driver's seat is to detect the driver's weight, or mounted onto a measuring means to measure the vehicle weight. However, this conventional technique does not take the chassis characteristics into account, so it is unable to fully carry out the detecting function of a stress or strain sensor and further to make the vehicle intelligent.

Therefore, it is desirable for the vehicle industry to provide an intelligent vehicle that combines artificial intelligent technology to give a quick response to any variation of stress and to detect the parameters of the vehicle, such as vehicle weight, tire pressure, impact, temperature, wheel alignment, etc.

U.S. Patent Pub. No. 2006/0030974 disclosed a vehicle motion control device capable of controlling the driving force distribution to the wheels.

U.S. Pat. No. 6,651,518 disclosed that a device for measuring action force of a wheel includes a stress detection sensor installed in a hole of a vehicle axle of the wheel and a signal processing circuit provided for processing a detection signal from the stress detection sensor.

U.S. Patent Pub. No. 2005/0143891 disclosed that a control system for a vehicle includes one or more sensor assemblies mounted to a vehicle frame (i.e. chassis) with each sensor assembly including one or more strain sensors for sensing strain on the vehicle frame in such a way that the operation of components of the vehicle can be controlled.

U.S. Pat. No. 4,149,140 disclosed an apparatus for detecting a change of pressure in tire pressure of a dual wheel tire, in which the strain gauges are affixed to the axle housing.

Japanese Patent Pub. No. 04-331336 was provided with some drawings identical to those of the aforesaid '518 patent and disclosed that the strain gauge in FIG. 19 is mounted at X, Y, and Z directions.

U.S. Patent Pub. No. 2005/0240321 disclosed that the strain gauge is a piezoelectric strain gauge.

U.S. Pat. No. 6,595,045 disclosed that the sensor on the axle is a strain gauge based on temperature compensation.

The current small car, e.g. sedan, has been designed to have the monocoque without any chassis but with a body floor made of sheet metal by press molding and a housing combined with the body floor and made of sheet metal by press molding. The structural strength of such monocoque is sufficient for what the general small sedan needs, such that the monocoque has been widely applied to the small sedan.

All of the above-identified prior art did not disclose that the strain gauge is mounted onto the housing to detect deformation of the housing.

### SUMMARY OF THE INVENTION

The primary objective of the present invention is to provide a monocoque of a vehicle, which can detect deformation of a housing of the vehicle.

The secondary objective of the present invention is to provide a monocoque of vehicle, which can provide information for an external device, like microcomputer, to identify the current status (tire pressure) of the vehicle.

The foregoing objectives of the present invention are attained by the monocoque composed of a monocoque, a plurality of support frames, a plurality of tire brackets, and a plurality of stress-strain sensors. The monocoque includes body floor and a housing combined with the body floor and made of steel or plastic steel. The support frames are mounted to the housing. The tire brackets are mounted below the support frames respectively. A tire is mounted to each of the tire brackets for supporting the weight of the whole vehicle via the support frames and the tire brackets. The stress-strain sensors are mounted to respective parts of the housing and located above the support frames for detecting the amount and direction of a strain applied to those parts of the housing in such a way that the housing becomes a big scale strain detector. Strain data generated while the stress-strain sensors function can be provided for identifying the strain applied to the monocoque, such that the present invention can provide preferable status of the monocoque of the vehicle.

### BRIEF DESCRIPTION OF THE DRAWINGS

FIG. 1 is a schematic side view of a first preferred embodiment of the present invention, illustrating the relationships among the body floor, the housing, and the tires.

FIG. 2 is a schematic top view of the first preferred embodiment of the present invention, illustrating that the stress-strain sensors are mounted to the housing; the roof of the housing is not shown to prevent it from shading the stress-strain sensors.

FIG. 3 is schematic view of a part of the first preferred embodiment of the present invention.

FIG. 4 is a circuit block diagram of the first preferred embodiment of the present invention.

FIG. 5 is a schematic drawing showing the structure of the detecting circuit of the stress-strain sensor according to the first preferred embodiment of the present invention.

FIG. 6 is a circuit block diagram of a second preferred embodiment of the present invention.

FIG. 7 is a schematic drawing showing the structure of the detecting circuit of the stress-strain sensor according to the second preferred embodiment of the present invention.

### DETAILED DESCRIPTION OF PREFERRED EMBODIMENTS

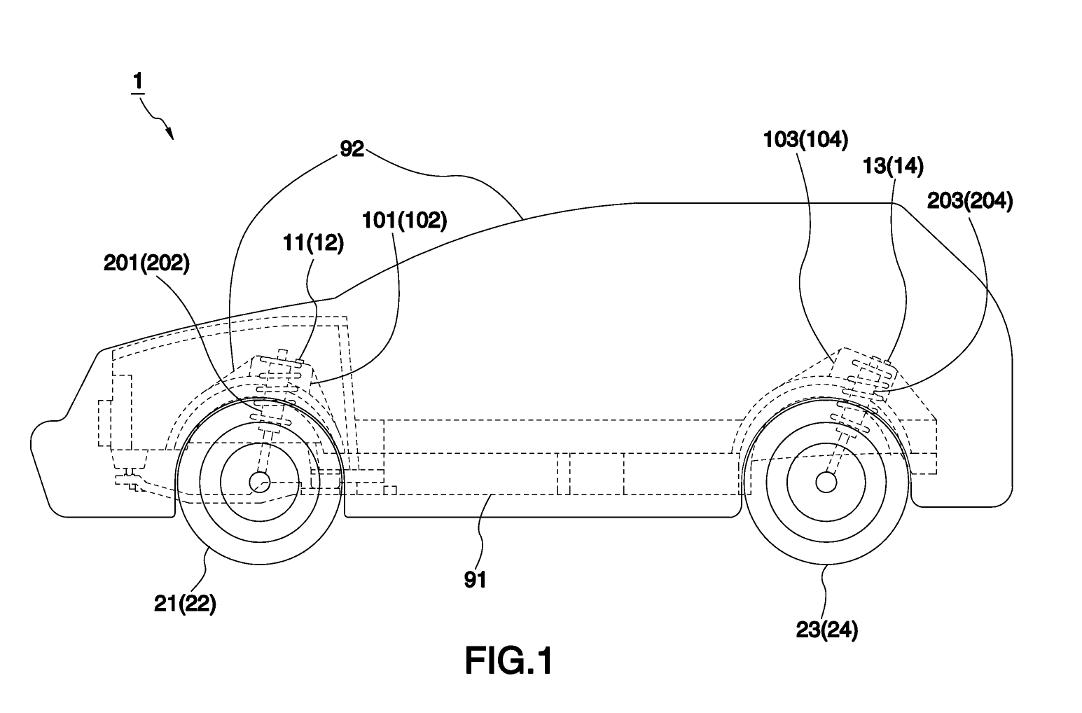

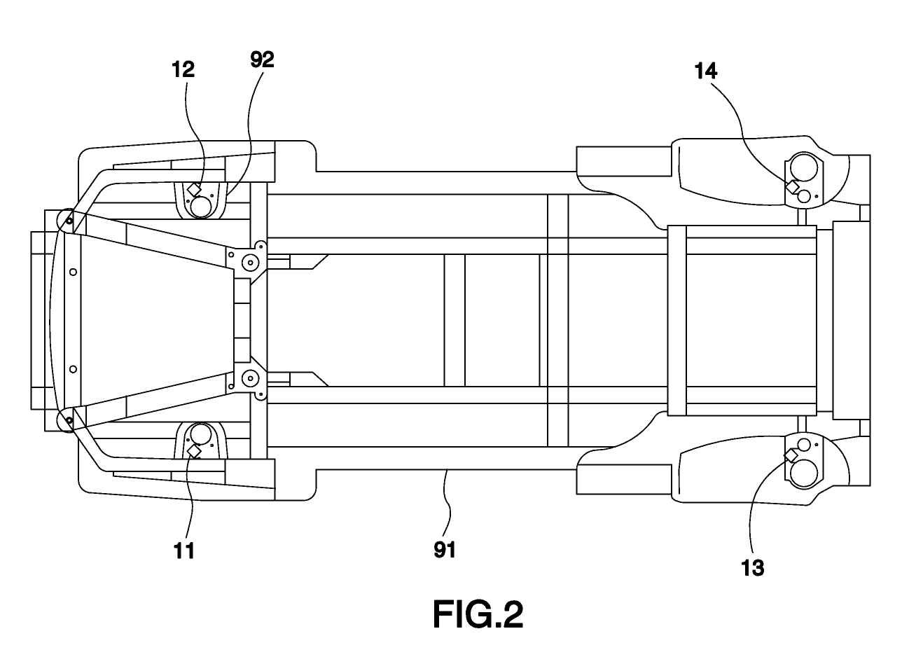

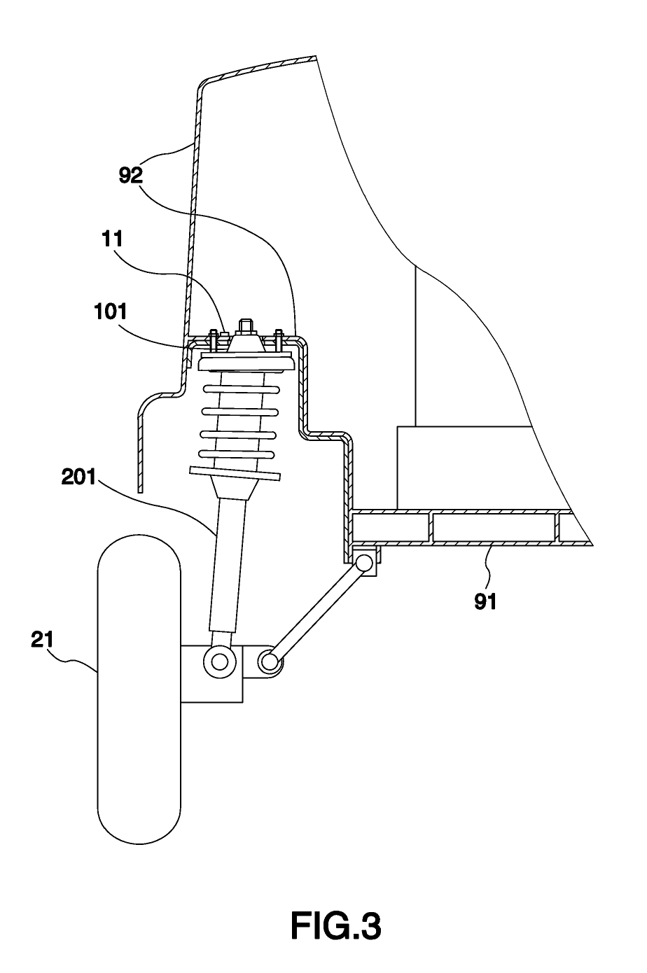

Referring to FIGS. 1 & 3, a monocoque 1 of a vehicle capable of detecting strain in accordance with a first preferred embodiment of the present invention is composed of a body floor 91 and a housing 92 combined with the body floor 91 and made of steel. The housing 92 can alternatively be made of plastic steel. The detailed descriptions and operations of these elements as well as their interrelations are recited in the respective paragraphs as follows.

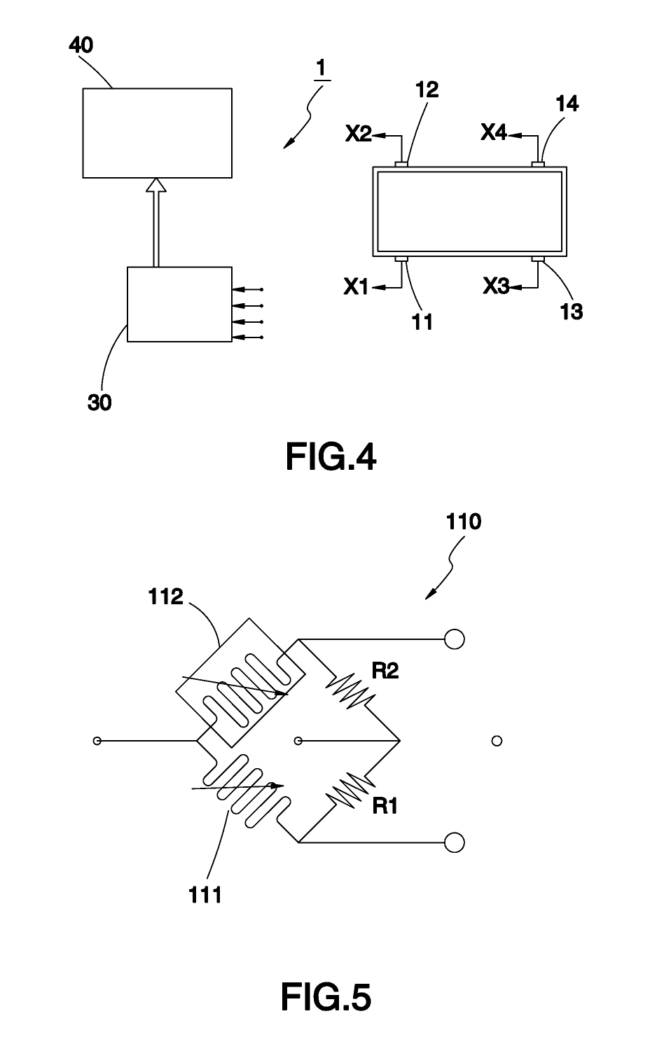

The housing 92 includes four support frames 101, 102, 103 & 104, four tire brackets 201, 202, 203 & 204, and a plurality of stress-strain sensors 11, 12, 13 & 14. The four support frames 101-104 are mounted to the housing 92. The four tire brackets 201-204 are mounted below the four support frames separately. The vehicle includes a plurality of tires. In this embodiment, there are four tires 21, 22, 23 & 24 mounted to the tire brackets 201-204 separately for supporting the weight of the whole vehicle through the support frames 101-104 and the tire brackets 201-204. The stress-strain sensors 11-14 are located above the support frames 101-104. In this way, the housing 92 itself works as a big scale strain detector. When the housing 92 is in a stable condition to receive reactive forces from the tires 21-24, the stress-strain sensors 11-14 can rapidly respond to the amount of strain of this stable condition and transmit respective strain data X1, X2, X3, and X4 to a microprocessor 30 through a wireless transmission method, as shown in FIG. 4.

Referring to FIG. 5, the stress-strain sensor 11 includes a detecting circuit 110, which is a Wheatstone Bridge circuit comprised of a first variable resistor formed of a strain meter 111, a second variable resistor formed of a temperature compensation strain meter 112, and two fixed resistors R1 and R2. The temperature compensation strain meter 112 is installed in a detection base of same material as the housing 92 so that the temperature compensation strain meter 112 can compensate for the amount of deformation caused by the surrounding temperature at the detecting circuit 110. Therefore, the stress-strain sensor 11 is free from the influence of the surrounding temperature and can accurately detect the amount of deformation of the housing 92 around the area at which it is located. The other stress-strain sensors 12-14 are made in the same manner. Therefore, the stress-strain sensors 11-14 each provide a respective strain data X1-X4 corresponding to the respective location to the microprocessor 30 for further calculation and recording.

When the vehicle is in a stable condition, the detecting points each provide a respective reference strain data X1-X4, i.e. the respective initial value. When the housing 92 is in a different temperature condition and carrying a different load, the detecting points respectively provide another strain data X1′, X2′, X3′ and X4′. Upon receive of this set of stain data X1′, X2′, X3′ and X4′, the microprocessor 30 compares the data with the storage reference stain data X1, X2, X3 and X4, and then calculate the difference so as to obtain the amount of deformation of the monocoque 1 and to output the calculation result to a display monitor 40 for display, enabling the user to know the message.

In an example of a particular model of vehicle, when the total weight of the vehicle is transmitted to the stress-strain sensors 11-14 through the support frames 101-104 of the housing 92, the stress-strain sensors 11-14 each provide a respective reference strain data X1-X4 in response to the total weight of the vehicle for use as the respective initial value. When the total weight of the vehicle changed, the stress-strain sensors 11-14 each provide a respective different strain data X1′-X4′ in response to this change. This amount of variation at each detecting point is recorded so as to form a set of standard weight-strain data for this vehicle model, and a table of weight-strain data is then built in the microprocessor 30. Thus, an intelligent product is provided for use to indicate the weight of this vehicle model at whatever time.

In an example of local variation of weight where the weight of the vehicle is not evenly distributed through the wheels 21-24 but biased against a specific detecting point, the amount of variation at such a specific location will be relatively greater during detection, and the other detecting points will show a respective strain mode of different proportion of amount of deformation. By means of this strain mode, the distributed of the increased weight is measured. Therefore, the housing 92 can be used to measure the distribution of weight of the vehicle at different locations. A regular strain sensor has a directional limitation, i.e. the stress-strain sensors 11-14 can only accurately detect the amount of strain in a particular direction. In order to detect the amount of deformation in different directions accurately, it is suggested to install a number of stress-strain sensors at every detecting point in different directions. Therefore, three stress-strain sensors can be installed in each of the support frames 101-104 at X, Y and Z directions to form a Cartesian coordinate system, enhancing the accurate strain detection functioning of the housing 92.

With respect to the variation of tire pressure, when the tire pressure is low, a variation of bearing angle at every wheel 21, 22, 23 or 24 relative to the corresponding support frame 101, 102, 103 or 104 will be measured by the respective stress-strain sensors 11, 12, 13 or 14 for detecting whether the tire pressure is sufficient or not.

With respect to the wheel alignment function, when the wheels are not kept in balance, i.e. the tires 21-24 are not well aligned, the two opposite lateral sides of the housing 92 will be forced to produce a certain extent of deformation by the asymmetric force received from the support frames 101-104, therefore another type of strain mode will be produced at every detecting point. By means of the multi-point detection of the stress-strain sensors 11-14, the wheel alignment status of the housing 92 is detected.

With respect to impact detection, when one side of the body of the vehicle is slowly pressed by an external force to show a status similar to increase of local vehicle weight, however due to the existence of sideway component of force of vehicle weight, the strain mode produced by each of the stress-strain sensors 11-14 will be different from the strain mode produced by the stress-strain sensor due to increase of vehicle weight, therefore a stain mode of oppression at a particular point is detected. If the impact is a transient pressure to the vehicle, it can easily be detected. When encountered a road impact during running of the vehicle on the road, a transient variation of impact force will be produced, at this time the wheel(s) suspending in the air will provide a pull force to the housing 92, thereby causing a specific strain mode to be produced for recognition of the occurrence of the road impact.

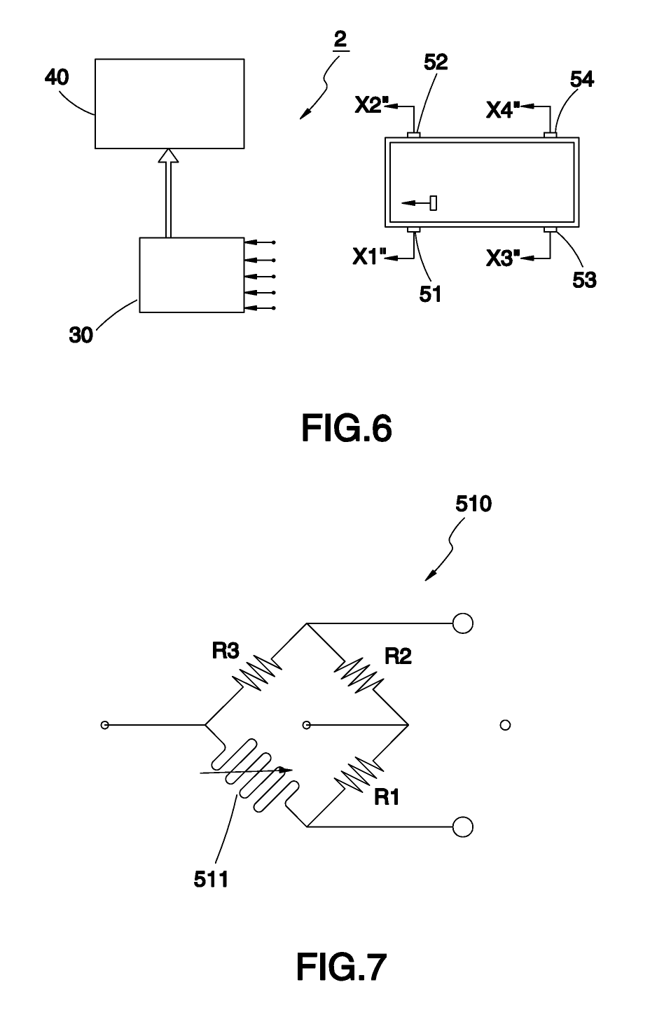

With respect to temperature compensation function, the invention provides a second embodiment. The monocoque 1 according to this second embodiment as shown in FIG. 6, is substantially similar to the aforesaid first embodiment. The housing 92 includes a plurality of stress-strain sensors 51, 52, 53, and 54 mounted thereon and a temperature-strain meter 55 that produces a strain mode subject to the variation of ambient temperature. According to this embodiment, the stress-strain sensors 51-54 do not provide a temperature compensation function. FIG. 7 shows the structure of the detecting circuit 510 of the stress-strain sensor 51. The detecting circuit 510 is a Wheatstone bridge circuit comprised of a strain meter 511 formed of a variable resistor, and three fixed resistors R1, R2, and R3. The detection circuit 510 responds to the amount of deformation under the current temperature. The other three sets of stress-strain sensors 52-54 have the same structure. Therefore, the stress-strain sensors 51-54 produce respective strain data X1″, X2″, X3″, and X4″ containing an effect of temperature. The temperature-strain meter 55 is adapted to detect the amount of deformation produced at the vehicle due to the change of surrounding temperature, thereby producing a strain data X5″ for temperature compensation, therefore, when compared with the reference data built in the microprocessor 30, the stress-strain sensors 51-54 accurately respond to the influence of the variation of temperature at the respective detecting point to the housing 92, and the variation value of the chassis affected by the surrounding temperature is measured.

Therefore, the user can know the variation of total weight of the vehicle, the variation of weight at a specific location in a specific direction, the variation of tire pressure of one specific wheel, the condition of an oppression (for example, impact) at one side of the vehicle, an unbalanced status of the wheels, or the variation of outside temperature at whatever time. Therefore, an intelligent vehicle made according to the present invention can detect various conditions and send the detected data to a microprocessor for processing, enabling the calculated result to be displayed on a display monitor, i.e. the invention enables a vehicle to become an intelligent machine.

The aforesaid strain meter 111 can be a piezo meter formed of a piezoelectric crystal that achieves the same stress and strain detection function. Further, a wired communication line may be installed and electrically connected between the stress-strains sensors and the microprocessor 30 to substitute for the aforesaid wireless communication method. Further, the invention is applicable to any of a variety of vehicles that carries a microprocessor.

Although the present invention has been described with respect to specific preferred embodiments thereof, it is in no way limited to the specifics of the illustrated structures but changes and modifications may be made within the scope of the appended claims.

What is claimed is:

1. A monocoque of a vehicle capable of detecting strain, comprising:
a monocoque having a body floor and a housing combined with the body floor and made of steel or plastic steel;
a plurality of support frames mounted to the housing;
a plurality of tire brackets mounted below the support frames for tires to be installed thereto respectively, whereby the tires can support the total weight of the vehicle through the tire brackets and the support frames; and
a plurality of stress-strain sensors mounted to the housing and located above the support frames for detecting the amount and direction of a strain applied to the housing so as to produce a respective strain data indicative of the amount and direction of the strain detected.

2. The monocoque as claimed in claim 1, wherein said at least one stress-strain sensor each is a strain meter.

3. The monocoque as claimed in claim 1, wherein said at least one stress-strain sensor each is a piezo meter formed of a piezoelectric crystal.

4. The monocoque as claimed in claim 1, wherein said at least one stress-strain sensor comprises a Wheatstone bridge circuit that comprises a variable resistor formed of a strain meter.

5. The monocoque as claimed in claim 4, wherein said Wheatstone bridge circuit further comprises a variable resistor formed of a temperature compensation strain meter and installed in a detecting base that is made of same material as that of the housing.

6. The monocoque as claimed in claim 1 further comprising a temperature-strain sensor mounted on a detecting base made of same material as that of the housing for providing a strain data for temperature compensation.

7. The monocoque as claimed in claim 1, wherein said at least one wheel bracket each has at least one of said at least one stress-strain sensor installed therein.

8. The monocoque as claimed in claim 7, wherein said at least one wheel bracket each has three said stress-strain sensors installed therein and arranged in X, Y and Z directions to form a Cartesian coordinate system.
